(19) United States
(12) Patent Application Publication
(10) Pub. No.: US 2003/0087654 A1
(43) Pub. Date: May 8, 2003

(54) Apparatus and method of compensation for signal time-of-arrival variation in a UMTS handset

(75) Inventor: Ashley Wheeler, Reading (GB)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/238,262

(22) Filed: Sep. 9, 2002

(30) Foreign Application Priority Data
Sep. 11, 2001 (GB) 0121987.2

(51) Int. Cl. H04B 7/005; H04B 7/01; H04B 7/015; H04B 15/00; H04B 7/00; H04Q 7/20; H04M 1/00; H04B 1/38

(52) U.S. Cl. 455/502; 455/516; 455/552

(57) ABSTRACT

Time base error in a dual mode mobile telephone is correct by measuring the time of arrival of a signal (6) comparing the time of arrival with an expected time of arrival (2). The time base error is corrected with a measured error signal (10, 12). An average time base error is derived from the measured errors over a predetermined period of time (14). From this, predicted error is used to correct the expected time of arrival of a signal (4).

This invention relates to a dual mode mobile telephone handset which operates on both the GSM and UMTS networks.

Dual mode mobile telephones of this type have to take regular synchronisation measurements with both the GSM and UMTS networks. When a phone is not in a call this is not a problem as there is plenty of time available to perform all the required measurements. Similarly, when the phone is in a call on the UMTS network, there are commands available which cause transmission gaps thereby freeing up time for synchronisation with the GSM network.

However, when the phone is in a call on the GSM network, measurement on the UMTS network can only be performed in idle periods which are one GSM frame in length and approximately one hundred and twenty milliseconds apart. Certain UMTS measurements take longer than one hundred and twenty milliseconds to perform and therefore have to be split over more than one idle frame. Therefore, to complete successfully such a measurement the handset has to keep track of the UMTS frame timing (as established in the first GSM idle frame) until the next GSM idle frame when the UMTS measurement can be continued or completed.

The accuracy required in this time base depends on the window size of the UMTS decoder. As window size relates directly to processing power required and hence to cost the power consumption of the decoder, the window size needs to be kept as small as possible. Unfortunately the only clock available to time the UMTS operations is the GSM one, and this can vary significantly in relation to the time base of the UMTS system. In addition, the time of arrival of UMTS signals can vary as the handset moves towards or away from the UMTS base station. Thus the size of the time base and time of arrival variations and hence the required window size depend on three factors:

1. The difference between the UMTS and GSM network clocks at the respective base stations.

2. Errors in the GSM clock caused by Doppler shift in the received GSM signal frequency (due to motion of the handset relative to the GSM base station), as the GSM clock will track at the received frequency, rather than the transmitted frequency of the GSM signals.

3. The varying timing delay experienced by the UMTS signals arriving at the handset due to motion of the handset relative to the UMTS base station.

Nothing can be done about point 1 within the handset. Point 2 can be compensated for using predictive techniques based upon the timing advanced (TA) mechanism provided in the GSM network. This can be addressed in our United Kingdom patent application no. 0109794.8 filed on Apr. 20, 2001.

A preferred embodiment of the present invention provides an apparatus for compensating for the varying time delay effects in UMTS (point 3 above). By minimising this source of UMTS timing error, particularly when combined with compensation for point 2, brings the required window size in the UMTS decoder down to plus or minus one sample and therefore reduces the required processing power by about 40%.

The invention is defined with more precision in the appended claims to which reference should now be made.

A preferred embodiment of the invention will now be described in detail by way of example with reference to the accompanying figures in which:

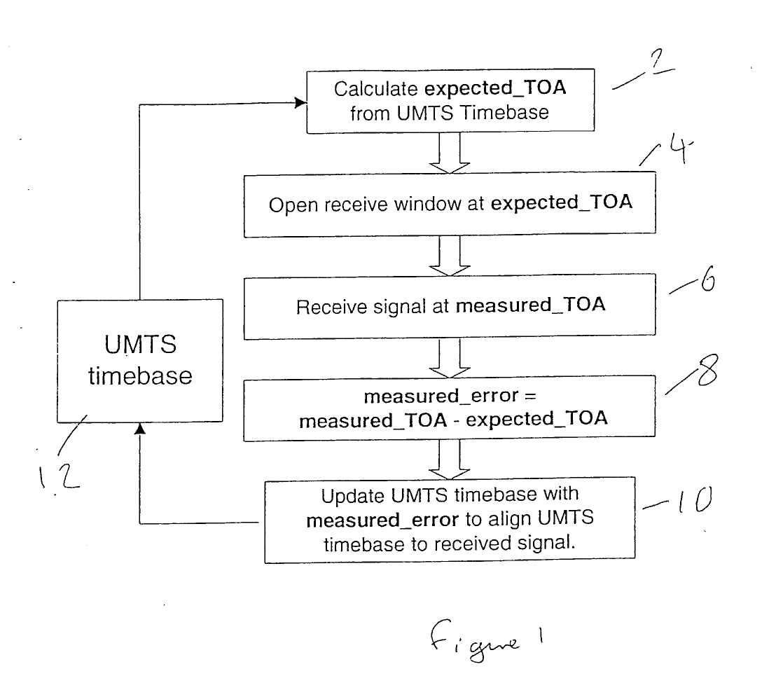

FIG. 1 is a block diagram of an existing burst mode receive process; and

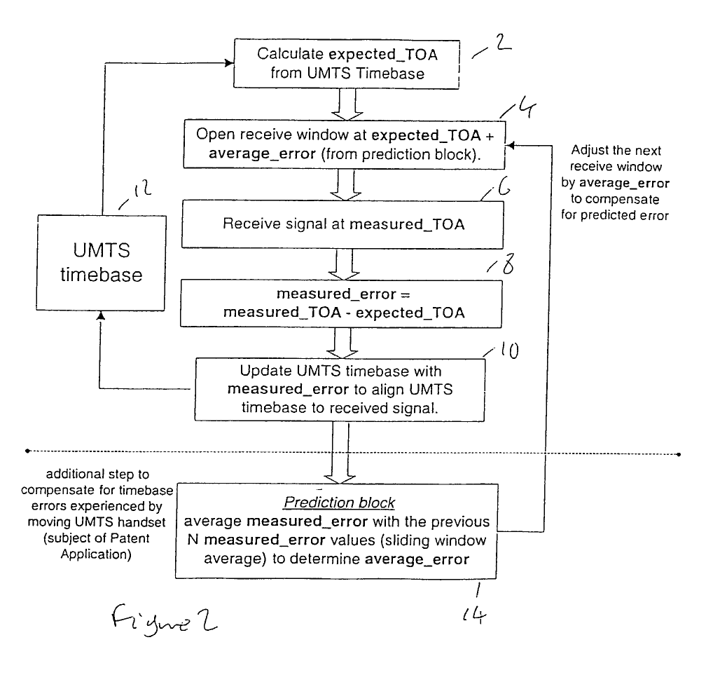

FIG. 2 is a block diagram of a burst mode receive process embodying the invention.

The time taken by a signal to travel from a UMTS base station to a handset can be simply calculated, based on the speed of the signal and the distance it must travel. If the handset is in motion along the axis between receiver and transmitter then the absolute delay experienced by the signal from the time it is transmitted to the time it is received will vary in proportion to the distance travelled and the direction of the motion along the axis whilst the signal is travelling from the base station to the handset.

In the existing first mode receive process as shown in FIG. 1 the handset uses the GSM clock to determine when it expects the UMTS signal to arrive. This is done at step 2 and a receive window is open at the expected time of arrival at step 4. The actual time of arrival of the signal is measured at box 6 and the error between the measured time of arrival and expected time of arrival is derived at step 8. An update for the UMTS time base is derived from the measured error at step 10 and applied to the UMTS time base at step 12. This time base is then used to calculate the expected time of arrival of the next UMTS signal at 2.

In this embodiment, the handset uses the GSM clock to determine when it expects the UMTS signal to arrive and opens a receive window accordingly. By measuring the difference between the expected time of arrival and the actual time of arrival of a signal, a measure of the combined effects of GSM clock time base error and any change in UMTS signal delay will be captured. If the effects of the GSM time base error (point 2 above) are minimised using the techniques described in UK patent application no. 0109794.7, the resulting difference will be reduced and should then be predominantly a measure of the change in signal propagation delay due to motion of the handset since the last signal was received. The method set out in UK patent application no. 0109794.8 corrects the Doppler Shift in GSM signals with a mobile handset by using timing advance signal to determine the rate of change of motion of the handset in relation to the base station. Timing advance is a rough measure of the distance between the handset and the base station having a resolution of approximately 55 metres. Changes in timing advance data are detected and after a predetermined interval of time, the timing advance data is examined again to see if it has changed. If it has, then a correction for the UMTS signal is derived.

A preferred embodiment of the invention compensates for the measured timing difference which is now predominantly due to the change in signal propagation delay by measuring the timing difference and storing and comparing this with a number of previously recorded values to determine the current average rate of change of delay. This average rate of change of delay can then be used to determine the next expected time of arrival to thereby minimise the difference between expected and actual signal time of arrival caused by predictable changes in signal propagation delay. In this way, information on previous changes to UMTS signal propagation delay are used to predict future variations and thus to reduce the required window size.

The system of FIG. 2 shows what happens at a handset embodying the invention. This is similar to FIG. 1, except that there is a prediction block 14 provided which takes a sliding window average of the measured errors derived in step 8 to determine an average error in the difference between measured time of arrival and expected time of arrival. A predetermined maximum number of samples is used and this number can be varied as desired. Usually it will be set within the handset. This average error is then used at step 4 as a correction to the expected time of arrival. Thus, for example, with a handset which is moving at a steady speed, the average error will be relatively constant and this should give good correction. Even for handsets which are not moving at steady speed, some benefit will be derived from correction by the average error.

In particular, by tracking the average time base error it is possible to provide a predicted correction for time base error, thereby reducing the actual time base error encountered. In a moving car on e.g. a motorway travelling at constant speed this should essentially eliminate time base error. With more sporadic movement the correction will be less useful but the system can be set up to adapt to underlying trends in time base error.

1. A method for correcting for time base error in a mobile telephone in the UMTS mode of operation comprising steps of:
measuring the time of arrival of a signal,
comparing the time of arrival of a signal with the expected time of arrival to derive a time base error signal,
correcting the time base for time base error,
deriving an average time base error value over a predetermined period of time,
applying a predicted time base error to the expected time of arrival to reduce the magnitude of the derived time base error.

2. Apparatus for correcting for time base error in a mobile telephone, in the UMTS mode of operation, comprising means for measuring the time of arrival of a signal, means for deriving a time base error from the measured time of arrival and an expected time of arrival of the signal, means for correcting the time base with the time base error, means for deriving an average,time base error over a predetermined period of time, means for applying a predicted correction to the expected time of arrival to reduce the magnitude of the time base error.

3. A method for correcting for UMTS time base error in a dual mode mobile telephone substantially as herein described.

4. Apparatus for correcting for UMTS time base error in a dual mode mobile telephone substantially a herein described with reference to the accompanying figure.
